(19) United States
(12) Patent Application Publication
(10) Pub. No.: US 2015/0045109 A1
(43) Pub. Date: Feb. 12, 2015

(54) GAME CHARACTER GENERATING METHOD, SERVER, AND RECORDING MEDIA

(71) Applicant: INTELLECTUAL DISCOVERY CO., LTD, Seoul (KR)

(72) Inventor: Jae Ick Shin, Seoul (KR)

(73) Assignee: INTELLECTUAL DISCOVERY CO., LTD., Seoul (KR)

(21) Appl. No.: 14/386,281

(22) PCT Filed: Dec. 20, 2012
(86) PCT No.: PCT/KR2012/011137

§ 371 Date: Sep. 18, 2014

(30) Foreign Application Priority Data
Apr. 20, 2012 (KR) 10-2012-0041266

(51) Int. Cl. A63F 13/67; A63F 13/58; A63F 13/48

(52) U.S. Cl. CPC A63F 13/67; A63F 13/48; A63F 13/58
USPC 463/23

(57) ABSTRACT

A method for generating a game character according to the present invention includes: a step of providing a tutorial game to measure an ability of a user in a game to a user terminal; and a step of controlling to generate the character for the game corresponding to the ability measured in the tutorial game when the user of the user terminal performs a tutorial game.

### TECHNICAL FIELD

The present invention relates to a method for generating a game character, a server thereof, and a recording media, and in detail, relates to a method for generating a game character to generate the game character according to an ability of a game user, a server thereof, and a recording media.

### BACKGROUND ART

Recently, a service providing various contents on the internet has appeared with development of a dissemination environment of a network, and among content providing services, a game content providing service corresponds to a field in which expansion of the market and a dissemination speed are most rapidly increased.

Also, the development speed and the dissemination speed of the service are rapidly increased with the proliferation of a demand layer, and as the number of users using the game service is rapidly increased, the game services that were available free are converted to be paid services.

The online game content providing service has a merit that the same game may be played with an unspecified person in remote locations without the constraints of time and space.

As described above, as the rapid increasing number of users using the game service through the internet and the charging for the game service are progressed, each portal site and companies of the online game service develop services of various kinds to create a profit.

Currently, the online game service provided to the game user may generate a character regardless of the ability of the game user, and may perform the game such that the game is not performed between similar game users.

The above information disclosed in this Background section is only for enhancement of understanding of the background of the invention and therefore it may contain information that does not form the prior art that is already known in this country to a person of ordinary skill in the art.

### DISCLOSURE

### Technical Problem

Accordingly, the present invention provides a method for generating a game character according to the ability of the game user, a server, and a recording media.

### Technical Solution

A method for a game server to provide a game according to an exemplary embodiment of the present invention includes: a step of providing a tutorial game to measure an ability of a user in the game to a user terminal; and a step of controlling to generate a character for the game when a user of the user terminal completes the tutorial game.

Before the step of controlling to generate the character, a step of determining whether the user completes the tutorial game may be further included.

The step of controlling to generate the character may further include a step of determining a game level of the user according to the completed tutorial game, and controlling to generate the character corresponding to the game level.

Also, the tutorial game may correspond to a game of other configurations that are not the same configurations as the game provided by the game server.

A step of repeatedly providing the tutorial game to the user terminal when the user does not complete the tutorial game may be further included.

A method for controlling to generate a game character according to another exemplary embodiment of the present invention through a game server providing the game may include: (a) a step of providing the tutorial game to measure the ability of the user in the game to the user terminal; (b) a step of determining whether the user completes the tutorial game; (c) a step of providing a higher level tutorial game that is more difficult than the tutorial game when the user of the user terminal completes the tutorial game; and (d) a step of generating the character for the game corresponding to the ability measured in the tutorial game when the step (c) is repeatedly provided and the user completes the tutorial game or the higher level tutorial game.

The step (d) may include a step of determining a game level of the user according to the completed tutorial game or the higher level tutorial game and controlling to generate the character corresponding to the game level.

The step (b) may include a step of repeatedly providing the tutorial game when the user does not complete the tutorial game as the determining result.

The step of providing the tutorial game when the user does not complete the tutorial game may be provided a predetermined number of times.

The step (b) may include a step of determining the game level of the user as a predetermined lowest level when the user does not complete the tutorial game during the predetermined number of times.

A server for generating a game character may include: a tutorial management module providing a tutorial game to measure an ability of a user in a game to a user terminal; and a character generating module generating a character for the game when the user of the user terminal completes a tutorial game provided by the tutorial management module.

A control module determining whether the user completes the tutorial game provided by the tutorial management module may be further included.

A level management module to determine the game level of the user according to the completed tutorial game when the user completes the tutorial game provided by the tutorial management module may be further included.

The character generating module may be controlled to generate the character corresponding to the game level of the user determined by the level management module.

The tutorial management module may repeatedly provide the tutorial game to the user terminal when the user does not complete the tutorial game by the control module.

The methods according to an exemplary embodiment of the present invention may be implemented by being programmed to a computer readable recording media.

### Advantageous Effects

The method for generating the game character, the server, and the recording media according to the present invention only select the game user that may be adapted to the game, and the game is played between game users having similar ability such that the joy of the game may be increased.

The method for generating the game character, the server, and the recording media according to the present invention reduce an initial departure ratio of game user, of a game, thereby contributing to the game's success.

### DESCRIPTION OF THE DRAWINGS

In order to more fully understand the drawings cited in the detailed description of the Invention, a brief description of each drawing is provided.

FIG. 1 is a view showing a system for generating a game character according to an exemplary embodiment of the present invention.

FIG. 2 is a view further concretely showing a game server of FIG. 1.

FIG. 3 is a view showing a method for generating a game character according to an exemplary embodiment of the present invention.

FIG. 4 is a view showing a method for generating a game character according to an exemplary embodiment of the present invention.

FIG. 5 is a view showing a method for generating a game character according to an exemplary embodiment of the present invention.

FIG. 6 is a view showing a method for generating a game character according to an exemplary embodiment of the present invention.

FIG. 7 to FIG. 9 are views showing a game screen to explain an exemplary embodiment of the present invention.

### MODE FOR INVENTION

Hereinafter, the present invention will be described in detail with reference to accompanying drawings.

In the following description, in order to clearly understand the present invention, description of a known technology regarding a characteristic of the present invention will be omitted. It is obvious that the following exemplary embodiment is a detailed description which is provided for better understanding of the present invention, and does not limit the scope of the present invention. Therefore, an equivalent invention which performs the same function as the present invention may also be covered by the scope of the present invention.

In the following description, like reference numerals designate like elements having the same configuration, and redundant description and description of a known technology will be omitted.

In an exemplary embodiment of the present invention, “communication”, “communication network”, and “network” may be used to have the same meaning. The three terminologies indicate a wired or wireless local area and wide area data transmitting/receiving network through which a file is transmitted/received between a user terminal, another user terminal, and a download server.

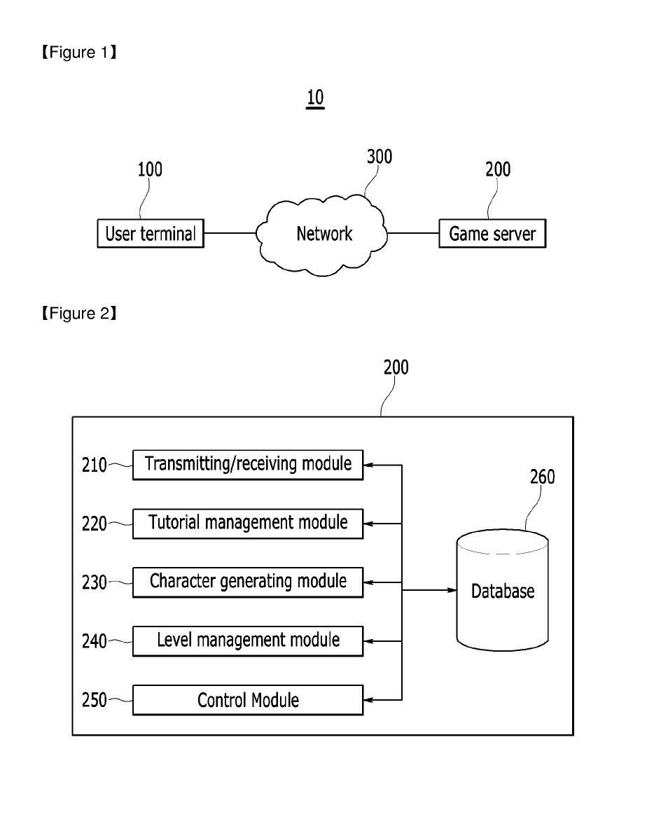

FIG. 1 is a view showing a system for generating a game character according to an exemplary embodiment of the present invention. A game character generating system 10 includes a user terminal 100 and a game server 200 connected to the user terminal 100 through a network 300.

Referring to FIG. 1, the game server 200 is connected to the user terminal 100 through the network 300, and may provide the game and the tutorial to the game user terminal 100 on the network 300 and may be provided to generate the character for the game to the user of the user terminal 100 playing the game.

Also, when the game server 200 is provided to generate the character to the user terminal 100, the game server 200 may provide the tutorial game to the user terminal 100, may set a level according to whether the tutorial game performed by the user terminal 100 is completed, and may be provided to generate the character corresponding to the level.

The game server 200 determines the users of the same level performing the game as having similar ability, and an original game provided by the game server 200 may be performed between the users of the same level.

The detailed description for the game server 200 will be realized in FIG. 2.

The user terminal 100 maintains a connection state through the network 300 such as the internet or a telephone, and for example, may correspond to a personal computer, a handheld computer, a personal digital assistant (PDA), a mobile phone, or a smart phone, and may correspond to a concept commonly naming a terminal having a predetermined calculating ability by mounting a microprocessor.

FIG. 2 is a view further concretely showing the game server of FIG. 1. The game server 200 includes a transmitting/receiving module 210, a tutorial management module 220, a character generating module 230, a level management module 240, a control module 250, and a database 260.

The transmitting/receiving module 210 performs a function for transmitting/receiving various data including the game and the tutorial game provided by the user terminal 100 and the game server 200.

The tutorial management module 220 performs a function of providing a tutorial game to measure the ability of the user in the game to the user terminal 100. At this time, the tutorial game may be formed of a tutorial game with several levels of difficulty, and the level may be provided by the level management module 240 according to each difficulty level. The tutorial game may correspond to a game of a different configuration from the game provided by the game server 200, and may correspond to a configuration of one mini-game for pre-measuring the ability in performing the game provided by the game server 200.

Also, the tutorial management module 220 may provide the tutorial game of the same difficulty to the user only a predetermined number of times.

The character generating module 230 provides a function of generating the character for the original game through the user terminal 100 when the user of the user terminal 100 completes the tutorial game provided by the tutorial management module 220.

The level management module 240 performs a function of setting the level based on the user of the user terminal 100 performing the tutorial game. For example, when the user of the user terminal 100 performs a fifth tutorial game, the level of the user terminal 100 may become 5.

Also, the level management module 240 may provide the level according to the corresponding difficulty to the user terminal 100 when providing the tutorial game of the same difficulty to the user only the predetermined number of times and the user does not complete the tutorial game during the predetermined number of times. For example, when the user does not complete the tutorial game during the predetermined number of 10 in an initial tutorial game, a minimum level may be set, and when the user does not complete the tutorial game during the predetermined number of 10 in the third initial tutorial game, level 3 may be set. However, this is only an example, and the range of the present invention is not limited thereto.

The control module 250 performs a function of determining whether the user completes the tutorial game provided by the tutorial management module 220.

The data base 260 performs a function of storing the game provided by the game server 200 and the character provided by the tutorial game and the user terminal 100.

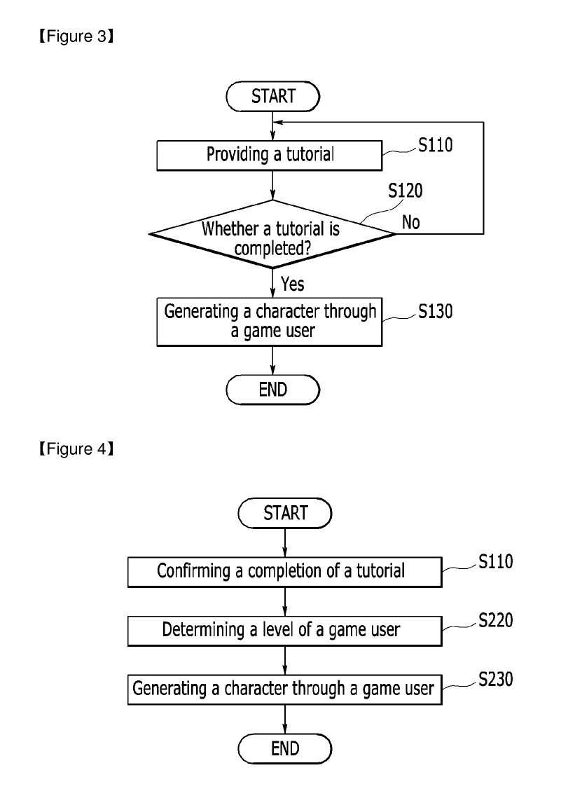

FIG. 3 is a view showing a method for generating a game character according to an exemplary embodiment of the present invention. The method for generating the game character of FIG. 3 may be performed in the game server 200 shown in FIG. 1.

Referring to FIG. 3, the tutorial game is provided by the game server 200 to the user terminal 100 (S110). When the user terminal 100 performs the tutorial game, the game server 200 determines whether the user terminal 100 completes the tutorial game (S120).

If the user terminal 100 does not complete the tutorial game, the tutorial game is again provided to the user terminal 100. In this case, a number of times that the tutorial game is again provided to the user terminal 100 may correspond to the predetermined number.

If the user terminal 100 completes the tutorial game, the game server 200 may generate the character to the user terminal 100 (S130).

FIG. 4 is a view showing a method for generating a game character according to an exemplary embodiment of the present invention. The method for generating the game character of FIG. 4 may be performed in the game server 200 shown in FIG. 1.

Referring to FIG. 4, the game server 200 provides the tutorial game to the user terminal 100 and confirms whether the user terminal 100 completes the tutorial game (S210).

Next, the game server 200 may determine the game level of the game user based on whether the user terminal 100 completes the tutorial game (S220). In this case, the user terminal 100 may perform the tutorial game of the several difficulty levels, and the user terminal 100 may perform the tutorial game of a further higher difficulty whenever the user terminal 100 performs and completes the game from the tutorial game having the lowest difficulty.

Next, the game server 200 may generate the character according to the game level to the user terminal 100 (S230).

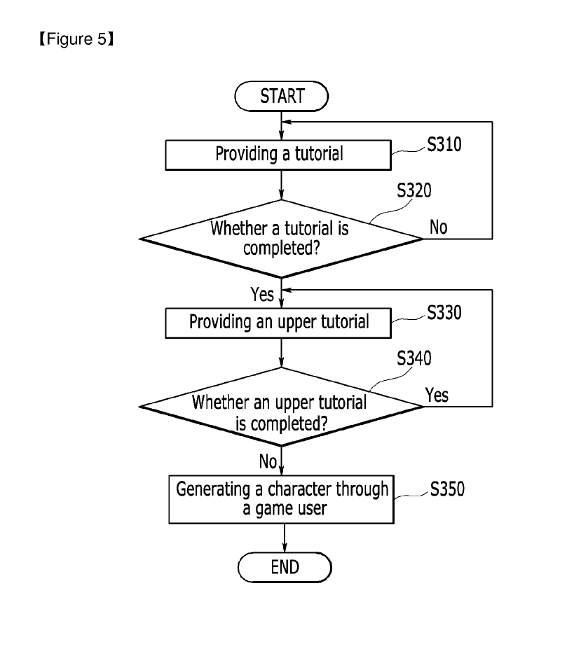

FIG. 5 is a view showing a method for generating a game character according to an exemplary embodiment of the present invention. The method for generating the game character of FIG. 5 may be performed in the game server 200 shown in FIG. 1.

Referring to FIG. 5, the game server 200 provides the tutorial game to the user terminal 100 (S310). If the user terminal 100 performs the tutorial game, the game server 200 determines whether the user terminal 100 completes the tutorial game (S320), and if the user terminal 100 does not complete the tutorial game, the tutorial game may be again provided. In this case, the number of times that the tutorial game is again provided may correspond to the predetermined number.

If the user terminal 100 completes the tutorial game, the game server 200 may provide a higher level tutorial game having more difficulty than the tutorial game to the user terminal 100 (S330).

If the user terminal 100 performs the higher level tutorial game, the game server 200 determines whether the user terminal 100 has completed the higher level tutorial game (S340), and if the user terminal 100 has completed the higher level tutorial game, a still higher level tutorial game having more difficulty than the higher level tutorial game may be provided. As described above, if the user terminal 100 continuously completes the tutorial game, the further higher level tutorial game may be provided the predetermined number of times.

If the user terminal 100 does not complete the higher level tutorial game, the game server 200 may be provided to generate the character of the level corresponding to the tutorial game that is completed to the user terminal 100 (S350).

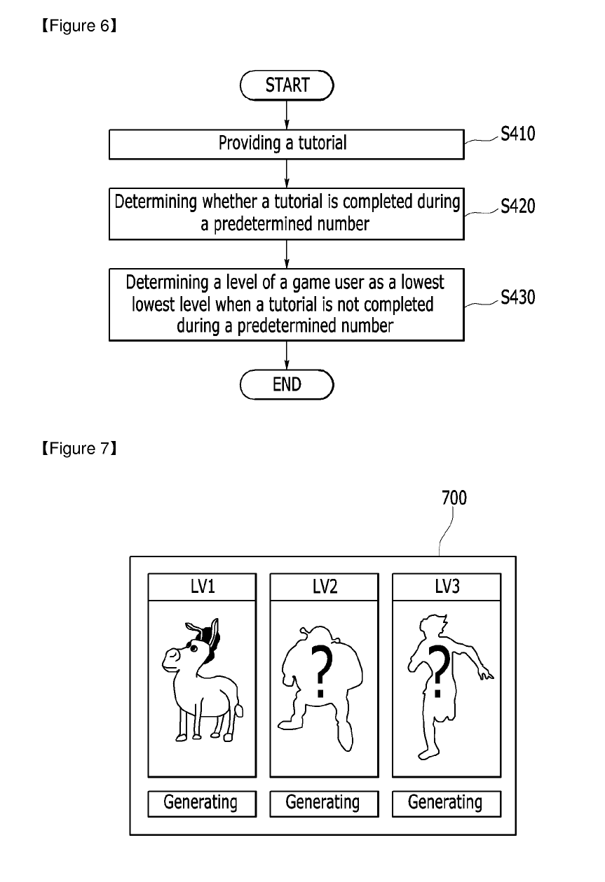

FIG. 6 is a view showing a method for generating a game character according to an exemplary embodiment of the present invention. The method for generating the game character of FIG. 6 may be performed in the game server 200 shown in FIG. 1.

Referring to FIG. 6, the game server 200 provides the tutorial game to the user terminal 100 (S410). The game server 200 provides the tutorial game to the user terminal 100 by the predetermined number of times, and determines whether the user terminal 100 performs and completes the tutorial game during the predetermined number of times (S420).

As the determining result, if the user terminal 100 does not complete the tutorial game during the predetermined number of times, the game level of the user of the user terminal 100 may be determined as a lowest level (S430). In this case, the lowest level is determined when the user terminal 100 does complete the initial tutorial game.

FIG. 7 to FIG. 9 are views showing a game screen to explain an exemplary embodiment of the present invention.

Referring to FIG. 7, on a game screen 700, it is described that the user terminal 100 generates the character. In the case of FIG. 7, since the user of the user terminal 100 completes the performance in the case of the initial tutorial game, only the character of LV1 may be generated and the characters of LV2 and LV3 may not be generated.

The case of the user terminal 100 corresponds to LV1 such that the game may be performed with other users corresponding to LV1 having the similar ability.

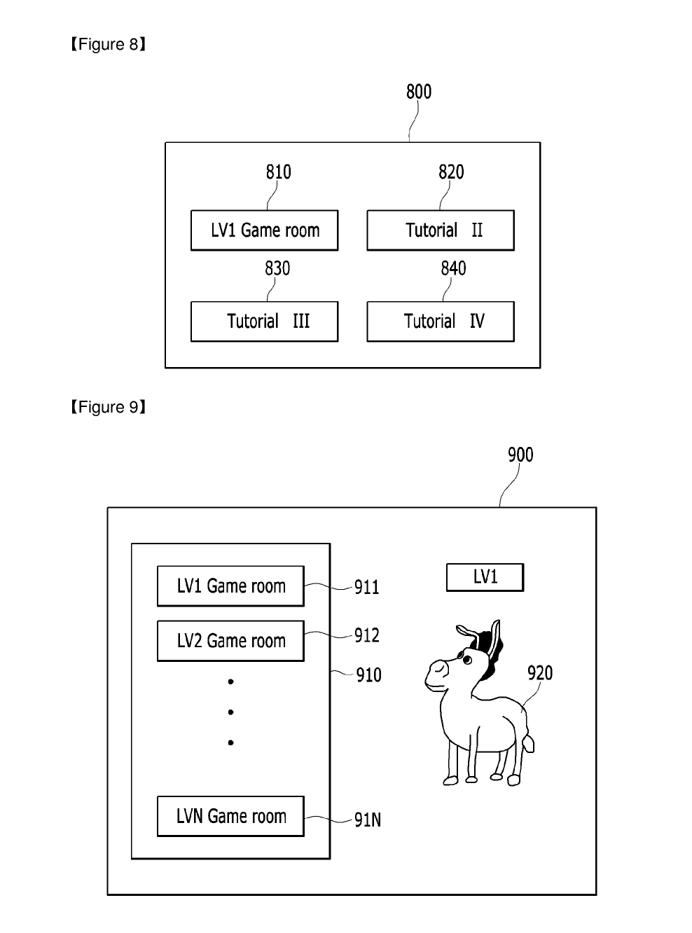

Referring to FIG. 8, on the game screen 800, the user terminal 100 may select one among tutorials 810 to 840. The game server 200 may provide the tutorial games 810 to 840 according to the difficulty to the user terminal 100. For example, the tutorial □810 may correspond to lowest difficulty and the tutorial □840 may correspond to highest difficulty. If the tutorial □810 is performed and completed by the user, the tutorial II 820 may be provided to the user terminal 100, and if the tutorial II 820 is performed and completed by the user, the tutorial III 830 may be provided to the user terminal 100, while if the tutorial III 830 is performed and completed by the user, the tutorial IV 840 may be provided to the user terminal 100. That is, the tutorial I 810 to the tutorial IV 840 may be sequentially provided according to the performance completion of the tutorial game of the user terminal 100.

In FIG. 8, it is described to the tutorial IV 840, but the range of the present invention is not limited thereto, and more tutorial games may be provided.

Referring to FIG. 9, on a game screen 900, a character 920 of the user terminal 100 corresponds to the level 1 LV 1, and accordingly, the tutorial I 810 of FIG. 8 corresponds to the state that the performance is not completed.

The user terminal 100 having the character 920 may only enter the LV1 game room 911 among a game room list 910, and may not enter game rooms of the other levels, for example, an LV2 game room 912 to an LVN game room 91N.

Accordingly, the user of the user terminal 100 having the character 920 has an effect of enjoying the game with the other users having the similar ability.

The method according to an exemplary embodiment of the present invention as described above may be executed by applications basically installed in the terminal (including programs included in a platform, an operating system, or the like which are basically installed in the terminal), and may also be executed by applications (i.e., programs) which are directly installed in the terminal by the user via an application store server or a web server associated with the applications or the corresponding services. The method according to an exemplary embodiment of the present invention as described above may be implemented by the applications (i.e., programs) which are basically installed or directly installed by the user in the terminal, and may be recorded in a computer readable recording medium of the terminal and the like.

The programs are recorded in the computer readable recording medium and are executed by the computer, such that the above-mentioned functions may be executed.

As described above, in order for the computer to read the programs recorded in the recording medium and execute the method according to an exemplary embodiment of the present invention, the above-mentioned programs may include codes which are coded with computer languages such as C, C++, JAVA, machine language, and the like which may be read by a processor (CPU) of the computer.

The code may include a function code associated with a function of defining the above-mentioned functions, and may also include an execution procedure related control code required for the processor of the computer to execute the above-mentioned functions according to a predetermined procedure.

Further, the code may include a memory reference related code indicating at which location (address number) of the memory inside or outside the computer additional information or media required for the processor of the computer to execute the above-mentioned functions needs to be referenced.

In addition, in order for the processor of the computer to execute the above-mentioned functions, when the processor needs to communicate with any other computers or servers, etc. at a remote location, the code may further include a communication related code regarding how the processor of the computer communicates with any other computers or servers at a remote location or which information or media the processor of the computer transmits and receives at the time of the communication, by using the communication module (for example, wired and/or wireless communication module) of the computer.

Further, a functional program for implementing the present invention, a code and a code segment associated therewith, and the like may be easily inferred or changed by programmers in the art to which the present invention pertains in consideration of a system environment of the computer which reads the recording medium and executes the program.

Hereinabove, examples of a computer readable recording medium recorded with programs as described above include a ROM, a RAM, a CD-ROM, a magnetic tape, a floppy disk, an optical media storage device, and the like.

Further, a computer readable recording medium recorded with programs as described above may be distributed to a computer system connected through a network and thus store and execute a computer readable code by a distributed manner. In this case, at least one computer among a plurality of distributed computers may execute a part of the above-mentioned functions and transmit the executed results to at least one of the other distributed computers, and the computer receiving the result may also execute a part of the above-mentioned functions and provide the executed results to the other distributed computers.

In particular, a computer readable recording medium recorded with applications, which are programs for executing the method in accordance with the exemplary embodiments of the present invention, may be a storage medium (for example, a hard disk and the like) included in an application store server or an application providing server such as a web server associated with applications or corresponding services, and the like, or the application providing server itself.

A computer, which may read a recording medium recorded with applications that are programs for executing the method in accordance with the exemplary embodiments of the present invention, may include not only a general PC such as a typical desktop and a laptop, but also a mobile terminal such as a smart phone, a tablet PC, a personal digital assistant (PDA), and a mobile communication terminal, and is to be construed as all the computable devices.

When a computer, which may read a recording medium recorded with applications that are programs for executing the method in accordance with the exemplary embodiments of the present invention, is a mobile terminal such as a smart phone, a tablet PC, a personal digital assistant (PDA), and a mobile communication terminal, the applications are downloaded from an application providing server to a general PC and thus may also be installed in the mobile terminal through a synchronization program.

Hereinabove, although it has been mentioned that all components configuring the exemplary embodiment of the present invention described hereinabove are combined with each other as one component or are combined and operated with each other as one component, the present invention is not necessarily limited to the above-mentioned exemplary embodiment. That is, all the components may also be selectively combined and operated with each other as one or more components without departing from the scope of the present invention.

In addition, although each of all the components may be implemented by one piece of independent hardware, some or all of the respective components which are selectively combined with each other may be implemented by a computer program having a program module performing some or all of functions combined with each other in one or multiple pieces of hardware. The codes and the code segments configuring the computer program may be easily inferred by a person having ordinary skill in the art to which the present invention pertains. The computer programs are stored in the computer readable media and are read and executed by the computer, and may implement the exemplary embodiment of the present invention. As the storage medium of the computer programs, a magnetic recording medium, an optical recording medium, and the like may be used.

Further, it will be understood that the terms “comprises” or “have” used in this specification may include the corresponding components unless explicitly described to the contrary, and therefore do not preclude other components but further include the components. In addition, unless defined otherwise in the detailed description, all the terms including technical and scientific terms have the same meaning as those generally understood by those skilled in the art to which the present invention pertains. Generally used terms such as terms defined in a dictionary should be interpreted as having the same meanings as those within a context of the related art, and should not be interpreted as ideally or excessively formal meanings unless clearly defined in the present specification.

The spirit of the present invention has been exemplified. It will be appreciated by those skilled in the art that various modifications and alterations can be made without departing from the essential characteristics of the present invention. Accordingly, the exemplary embodiments disclosed in the present invention do not limit but describe the spirit of the present invention, and the scope of the present invention is not limited by the exemplary embodiments. The scope of the present invention should be interpreted by the following claims, and it should be interpreted that all spirits equivalent to the following claims fall within the scope of the present invention.

1. A method for generating a game character through a game server providing a game, comprising;
a step of providing a tutorial game to measure an ability of a user in the game to a user terminal; and
a step of controlling to generate the character for the game corresponding to the ability measured in the tutorial game when the user of the user terminal performs a tutorial game.

2. The method of claim 1, further comprising,
before the step of controlling to generate the character,
a step of determining whether the user completes the tutorial game.

3. The method of claim 2, wherein
the step of controlling to generate the character further includes
a step of determining a game level of the user according to the completed tutorial game, and controlling to generate the character corresponding to the game level.

4. The method of claim 2, further comprising
a step of repeatedly providing the tutorial game to the user terminal when the user does not complete the tutorial game.

5. The method of claim 1, wherein
the step of controlling to generate the character for the game includes:
(b) a step of determining whether the user completes the tutorial game;
(c) a step of providing a higher level tutorial game that is more difficult than the tutorial game when the user of the user terminal completes the tutorial game; and
(d) a step of controlling to generate the character for the game corresponding to the ability measured in the tutorial game when the step (c) is repeatedly provided and the user completes the tutorial game or the higher level tutorial game.

6. The method of claim 5, wherein
the step (d) includes a step of determining a game level of the user according to the completed tutorial game or the higher level tutorial game, and controlling to generate the character corresponding to the game level.

7. The method of claim 6, wherein
the step (b) includes a step of repeatedly providing the tutorial game when the user does not complete the tutorial game as the determining result.

8. The method of claim 7, wherein
the step of providing the tutorial game when the user does not complete the tutorial game is provided a predetermined number of times.

9. The method of claim 8, wherein
the step (b) includes a step of determining the game level of the user as a predetermined lowest level when the user does not complete the tutorial game during the predetermined number of times.

10. A server for generating a game character, comprising:
a tutorial management module providing a tutorial game to measure an ability of a user in a game to a user terminal; and
a character generating module generating a character for the game when the user of the user terminal completes a tutorial game provided by the tutorial management module.

11. The server of claim 10, further comprising
a control module determining whether the user completes the tutorial game provided by the tutorial management module.

12. The server of claim 11, further comprising
a level management module to determine the game level of the user according to the completed tutorial game when the user completes the tutorial game provided by the tutorial management module,
wherein the character generating module is controlled to generate the character corresponding to the game level of the user determined by the level management module.

13. The server of claim 11, wherein
the tutorial management module repeatedly provides the tutorial game to the user terminal when the user does not complete the tutorial game by the control module.

14. A computer readable recording media recorded with a program to implement a method for generating a game character through a game server providing a game, comprising:
a step of providing a tutorial game to measure an ability of a user in the game to a user terminal; and
a step of generating a character for the game when the user of the user terminal completes the tutorial game.

15. The computer readable recording media of claim 14, wherein
the step of generating the character for the game includes:
(b) a step of determining whether the user completes the tutorial game;
(c) a step of providing a higher level tutorial game that is more difficult than the tutorial game when the user of the user terminal completes the tutorial game; and
(d) a step of generating the character for the game when the step (c) is repeatedly provided and the user does not complete the tutorial game or the higher level tutorial game.
